(19) United States
(12) Patent Application Publication
(10) Pub. No.: US 2004/0202356 A1
(43) Pub. Date: Oct. 14, 2004

(54) Optical detection of dental caries

(76) Inventors: George K. Stookey, Noblesville, IN (US); Kenneth R. Dunipace, Indianapolis, IN (US)

Correspondence Address: BAKER & DANIELS, 300 NORTH MERIDIAN STREET, SUITE 2700, INDIANAPOLIS, IN, 46204-1782, US

(21) Appl. No.: 10/411,625

(22) Filed: Apr. 10, 2003

(51) Int. Cl. G06K 9/00

(52) U.S. Cl. 382/128

(57) ABSTRACT

The present invention provides methods and system for easy detection of diseased tissue. The method of the present invention comprises the steps of quantifying fluorescence spectral values of a plurality of tissue regions of a target tissue, wherein the plurality of tissue regions represent stages of development of a disease; (b) transforming the fluorescence spectral values to produce enhanced spectral values for each tissue region; and (c) displaying an enhanced image of the plurality of tissue regions using the transformed spectral values, wherein the plurality of tissue regions appear substantially distinguishable. The system of the invention comprises a recording device for recording a fluorescence image of a target tissue having a plurality of regions, a processor operably coupled with the recording device for processing the image and producing spectral data, software operably coupled with the processor for transforming the spectral data into enhanced data, and a display screen operably coupled with software for displaying an enhanced image of the plurality of regions of the target tissue.

### BACKGROUND OF THE INVENTION

1. Field of the Invention

The present invention relates to a method for the digital detection of tissue lesions and, more particularly, pertains to a method for quantifying a probability of lesions existing in tissues.

2. Description of the Related Art

Dental caries are known to be a dynamic process which occurs at the molecular level. The carious lesions tend to increase in size relatively slowly, over many years. Diagnostic methods for detection of the disease have been reported. One nontraditional method may be referred to as “Quantitative Light-Induced Fluorescence” (QLF), which is based on the auto-fluorescence of teeth (see Inspektor Research Systems BV website). A summary of fluorescence in the hard, calcified tissues of human teeth has been presented by Hefferren, J. J., et. al. (1) (see cited references hereinbelow). In addition, the use of fluorescence in the detection of incipient caries has been reviewed by Angmar-Mansson, B. and ten Bosch, J. J. (2) (see cited references hereinbelow).

Generally, when teeth are illuminated with high intensity blue light they will emit light throughout the visible spectrum. The fluorescence of the dental material has a direct relation with the mineral content of the enamel. The fluorescence of carious tissue appears redder than that of sound tissue. Sometimes filtering out the blue green components of the fluorescence may make the change of the spectrum more apparent. However, for early caries, the change in color is small and is similar to the changes in overall intensity associated with irregularities on the surface of the tooth. More importantly, the reddish appearance of carious tissue is mainly the result of diminished blue and green components, rather than an increasing red component.

The method for detecting caries generally involves measurement of the degree of damage to the enamel by collecting digital images of each tooth with a small video sensor that is connected to a computer. In this way, the lesions may be visualized on the screen and the amount of enamel-loss may be analyzed and determined. Because the early-stage caries do not produce dramatic changes in color spectrum, visualization of the early-stage caries by traditional digital imaging is difficult. This difficulty leads to inaccurate assessment of the damage or the disease progressing without being detected. Therefore, further improvement of the digital imaging is needed so that early-stage caries may be detected and the disease may be timely treated before irreversible loss of tooth structure occurs.

### SUMMARY OF THE INVENTION

The invention provides methods and a system for detection of diseased tissue, such as tooth carious tissue, particularly, incipient tissue. The methods of the present invention generally involve identifying and quantifying spectral changes as tissue evolves from healthy to diseased, transforming spectral measurements representing the spectral changes and presenting the spectral changes for easy visual recognition.

Specifically, the method comprises the steps of quantifying spectral values of fluorescence from a plurality of regions representing stages of disease development of a target tissue, transforming the spectral values using a mathematical algorithm implemented by digital computer processing to produce enhanced spectral data, and displaying an enhanced image of the plurality of regions using the enhanced spectral data.

The present invention further discloses mathematical algorithms for transforming spectral measurements into enhanced spectral data based on spectral changes as tissue evolves from healthy to diseased.

The system of the invention comprises a recording device for recording a fluorescence image of a target tissue having a plurality of regions, a processor operably coupled with the recording device for processing the image and producing spectral data, software operably coupled with the processor for transforming the spectral data into enhanced data, and a display screen operably coupled with software for displaying an enhanced image of the plurality of regions of the target tissue using the enhanced data.

One advantage of the invention is that the distinction between the healthy tissue and the diseased tissue can be easily visualized.

Another advantage is that early stages of a disease can easily be detected so that early treatment can be implemented.

### BRIEF DESCRIPTION OF THE DRAWINGS

The file of this patent contains at least one drawing executed in color. Copies of this patent with color drawings will be provided by the Patent and Trademark Office upon request and payment of the necessary fee.

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1A is a data flowchart of imaging observed by human's eyes;

FIG. 1B is a data flowchart of imaging according to a method of the present invention;

FIG. 2 is a graphic illustration of fluorescence spectra of stages of development of tooth carie as reported in prior art;

FIG. 3 is a graphic illustration of combined RGB spectra recorded by SONY camera sensors;

FIG. 4 is a graphic illustration of red spectra for no-caries tissue;

FIG. 5 is a graphic illustration of green spectra for no-caries tissue;

FIG. 6 is a graphic illustration of blue spectra for no-caries tissue;

FIG. 7 is a graphic illustration of combined power spectra for no-caries tissue;

FIG. 8 is a graphic illustration of combined power spectra for initial-caries tissue;

FIG. 9 is a graphic illustration of combined power spectra for advanced-caries tissue;

FIG. 10 is a graphic illustration of combined power spectra for caries evolution;

FIG. 11 is a graphic illustration of display spectra of caries evolution;

FIG. 12 is a demonstration of digitally enhanced caries detection according to one embodiment of the invention;

FIG. 13 is a demonstration of digitally enhanced caries detection according to another embodiment of the invention; and

FIG. 14 is a commercial camera unit that can be used in the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF THE INVENTION

The embodiments disclosed below are not intended to be exhaustive or limit the invention to the precise form disclosed in the following detailed description. Rather, the embodiments are chosen and described so that others skilled in the art may utilize their teachings.

The present invention provides a method for detection of diseased tissue, such as tooth carious tissue, particularly, incipient tissue. The method generally involves capturing a fluorescent image of a target tissue by digital imaging, identifying and quantifying spectral changes as tissue evolves from healthy to diseased, transforming spectral measurements representing the spectral changes and presenting the spectral changes for easy recognition.

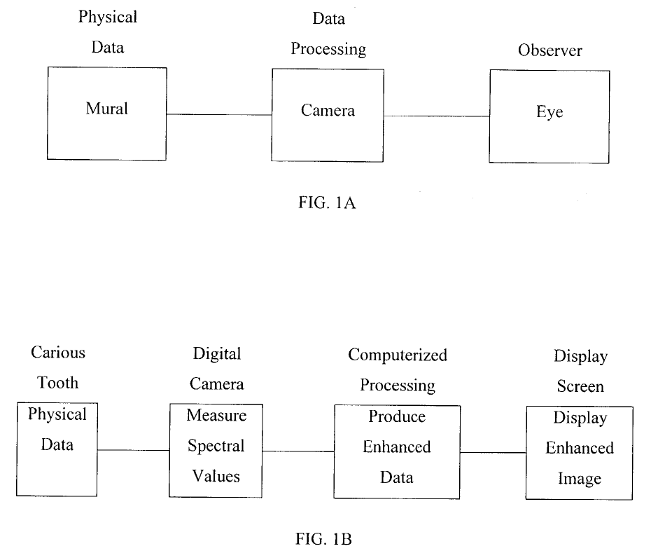

For the fluorescence of diseased tissue, as well as many other physical phenomena, the physical data are detected, recorded, transformed, and displayed for visualization. This general process is illustrated in FIG. 1A. Cameras process the physical data so it can be observed at a different time and place, but usually conveys the same information (the image) to the observer as would be perceived if the observer were viewing the data directly. In traditional detection methods, cameras have been used, with photographs or video displays, in the ordinary fashion to present an accurate reproduction of what the human eye could see.

The goal of the method of the present invention is to detect diseased tissue rather than to view the true image at a different time and place. In the present invention, the physical data is fluorescent light being emitted by a possibly carious tooth. The purpose of data processing is to display an image that facilitates caries detection, in contrast to a photographic image. The central part of the data processing is a transformation of the red, green, and blue components, or corresponding components of other color representations, from the recorded physical data to displayed image data (see FIG. 1B).

Some relevant characteristics pertaining to the present invention may be explained as follows. Light power passes through the lens of the human eye and is absorbed by cones. Power absorbed over a period of time is energy. When the energy level in a cone reaches a threshold level, the cone discharges the energy as a nerve impulse to the brain. The cone then repeats the process by again collecting energy. When the power level is high, the impulses to the brain are frequent and the brain interprets this as bright light. In a camera, the light power passes through the lens and is absorbed by sensors. For a camera, the length of time over which energy may be absorbed, the exposure can be adjusted. In the case of a camera, it is the amount of energy absorbed rather than the frequency of nerve impulses that indicates brightness.

Further, the inner surface of the eyeball is covered with many cones of three different types absorbing light that is near 580 nm, 520 nm, or 470 nm on the spectrum. Some cameras have sensors absorbing energies near these same wavelengths. The rest have some other combination working in an essentially similar way. Continuing the example of the mural in FIG. 1, each cone on the surface of the eyeball absorbs light from a specific location on the mural. Thus, the cones on the eyeball send impulses to the brain corresponding to the location of the image elements and, in the aggregate, send data corresponding to the entire surface of the mural. A typical commercial digital camera has an array that is 320 picture elements (pixels) high and 640 picture elements wide. Thus, the array is made up of 320×640=204,800 pixels. Each pixel absorbs light from a specific location on the mural, and again, in the aggregate, the array absorbs data corresponding to the entire surface of the mural. Each pixel has one of each kind of sensor (580 nm, 520 nm, and 470 nm). In both the eye and the camera, the entire spectral characteristic of a pixel is contained in the three energy values stored by the three sensors associated with that pixel. While the array in the eye is somewhat irregular and the array in the camera is precisely structured, the function of the respective arrays is similar. In the mathematical derivation below, the array of information from the camera can be processed for developing a display for the eye.

Another concept relevant to the method of the present invention relates to color. Color is also a function of the human system, mostly the brain. The three wavelengths mentioned above (580 nm, 520 nm, or 470 nm) cause the sensation described as red, green, and blue respectively. All of these sensors (eye and camera) respond to wavelengths that are some distance on either side of their nominal value. Indeed, it is this extended response that enable three sensors to detect, record, and display an infinite number of colors in the eye and a large number of colors in a camera image. For each pixel in an image recorded by the camera there will be three numbers, one for each sensor. In the Joint Pictures Expert Group (JPEG) format used to illustrate the present invention, the numbers can range from zero to 255, corresponding from no energy to maximum energy. As a result, this format may yield as many as 255³=16,581,375 colors. The three numbers (e.g. 255, 128, and 0) indicate the tone and brightness of the color of that pixel in the camera and the corresponding location on the mural. The number triple 255, 255, 255 represents bright white in the JPEG digital image format system (widely used for exchange of digital images between computers and over the internet), while 128, 0, 0 would represent a medium red. If image components that were recorded as bright white are to appear as medium red, a computer program may be written to test the Red, Green, and Blue (RGB) values at each recorded image pixel. Each time it found the combination 255, 255, 255 it would store values 128, 0, 0, otherwise it would store the recorded image values. This concept can be extended to define a formula converting every combination of R, G, or B values recorded by the camera into any desired value in the image displayed to the eye. Examples and mathematical processes to be described below demonstrate an application of the concept to the detection of tooth caries.

The present invention is described by reference to cameras with RGB sensors and JPEG format images. Again, to illustrate the invention, the analogy has been made to the human eye and the relative simplicity of the RGB and JPEG systems. The simulation below is based on a specific set of spectral data and a specific RGB camera. The invention and the claims of the invention that follow should not be understood as limited to the analogy to the human eye, or to the treatment of RGB colors by the JPEG system. The essential underlying strategy is not dependent on specific tissue, spectra, or camera. Cameras using other sensor/format systems such as CMY, CMYG, or other image formats such as TIFF could have been used. The process would be essentially the same. Similarly, the implementation illustrated below uses a specific linear transformation, but many other transformations may be used without essentially changing the process. The following examples are a series of simulations developed to illustrate and demonstrate the method of the present invention.

### EXAMPLE 1

### Identifying and Quantifying Spectral Changes as Tissue Evolves from Healthy to Diseased

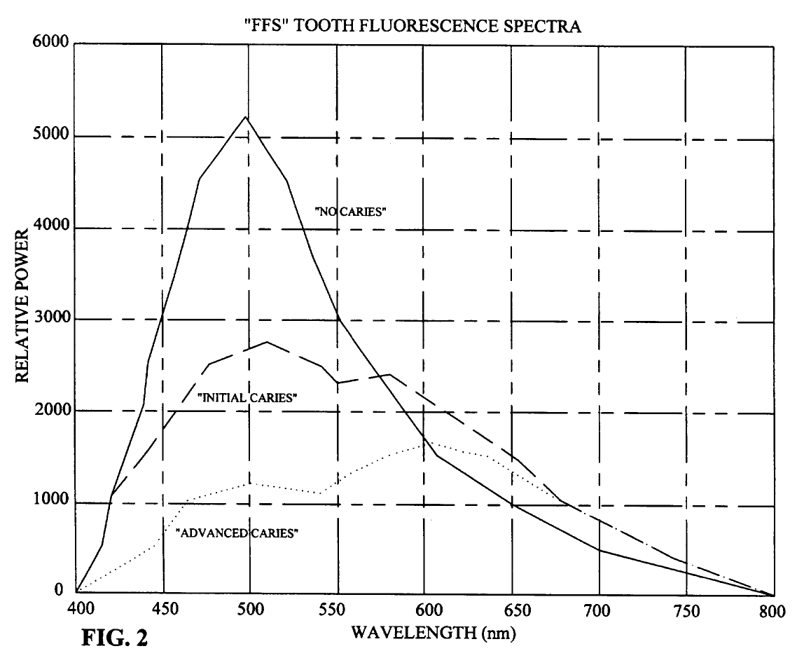

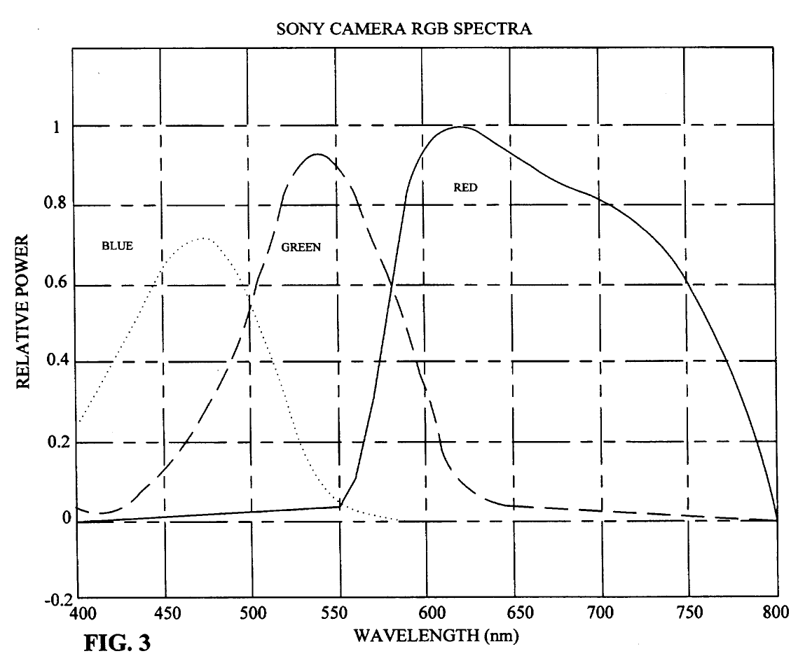

It assumes that caries fluorescence evolves as described by Fisher, et. al. (3) (“FSS” see cited references hereinbelow), hereby fully incorporated and shown in FIG. 2. It further assumes that a SONY ICX285AQ camera is used for capturing the simulated fluorescence image. The spectra associated with the sensors of this specific camera is shown in FIG. 3.

The first step in this simulation is to determine the energy values (R, G, and B) recorded by the digital camera for each stage of caries development. The three stages reported in reference 3 are No Caries (NC), Initial Caries (IC), and Advanced Caries (AC). The plots in FIG. 2 represent the light power emitted by the three kinds of tissue. The power values are only relative, having been scaled to fit conveniently on the graphs. The plots in FIG. 3 indicate how much of the light power entering the camera will be absorbed by each of the three camera sensors. These plots can be multiplied to show the power flowing into each sensor at each frequency from each tissue.

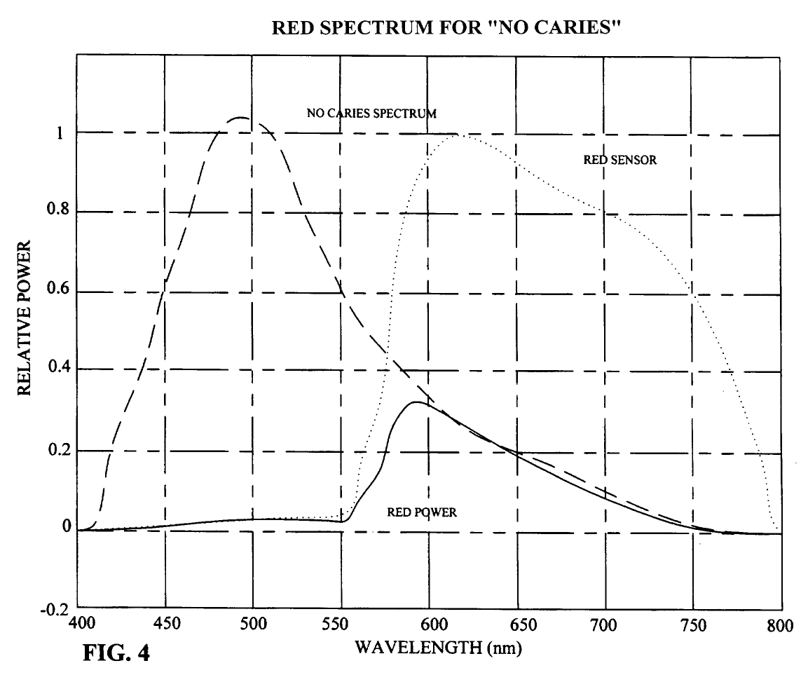

FIG. 4 shows this result for the NC tissue and the R sensor. The power plot in FIG. 4 is integrated mathematically to determine the total power flowing into the red sensor. The total power is then multiplied by the exposure setting of the camera to obtain the energy value for red. It represents the red component of fluorescence from a single pixel of sound tissue.

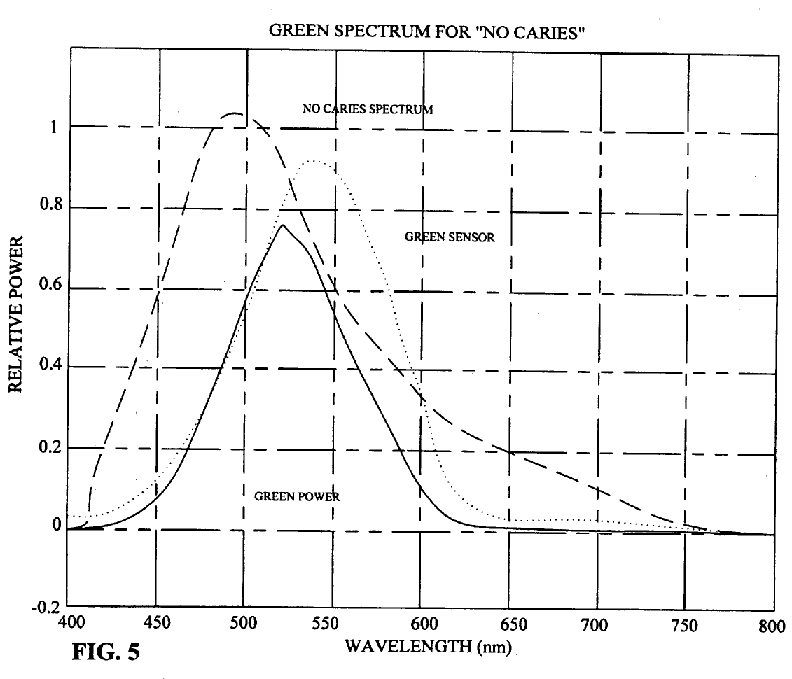

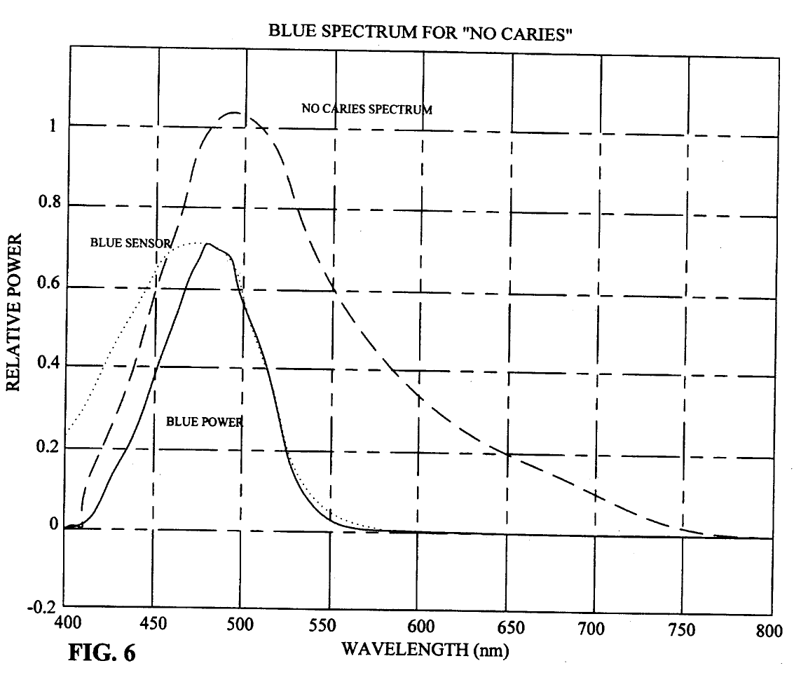

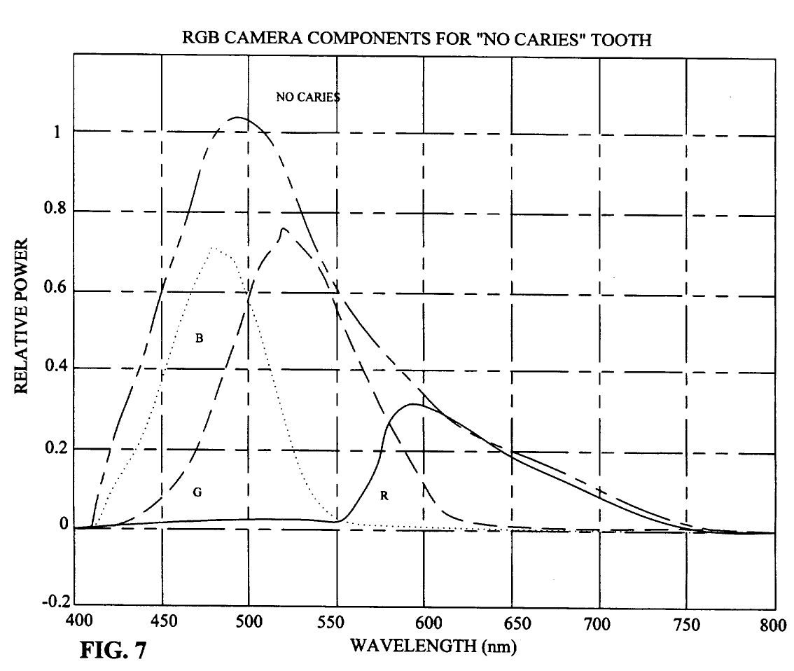

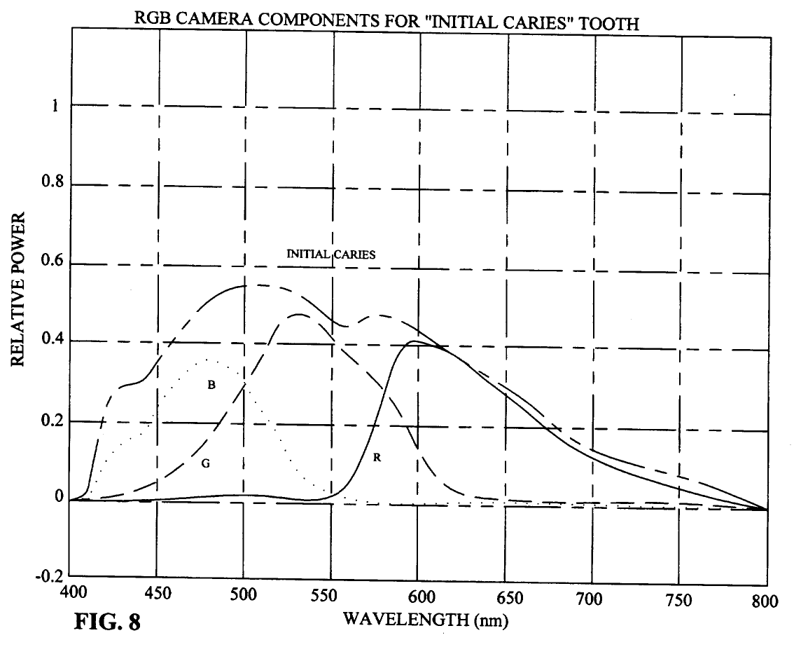

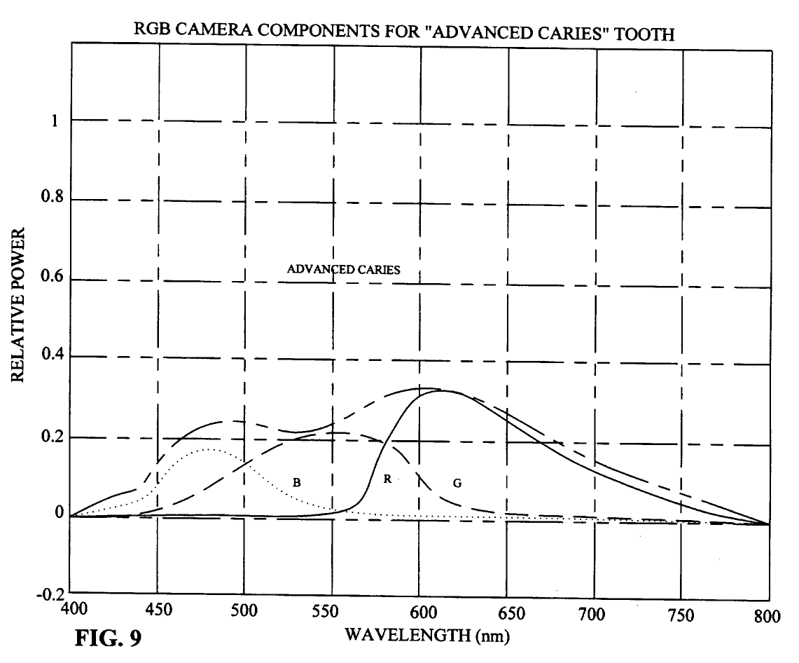

As noted above, the fluorescence spectra of NC tissue and the absorption spectrum of the red sensor are shown in FIG. 4 with the results of multiplying them together. The comparable information for the green and blue sensors is shown in FIGS. 5 and 6. The sensor power spectra from FIGS. 4, 5, and 6 are combined in FIG. 7. Thus, FIG. 7 represents the red, green, and blue components of fluorescence from sound tissue received by a single pixel. Similar power spectra were obtained for the IC and AC tissues, but only the combined (R, G, and B) results are included (FIGS. 8 and 9, respectively). The energy values associated with FIGS. 7, 8, and 9 are shown in TABLE I.

TABLE I
Calculated energy values absorbed by sensors of SONY ICX285AQ
camera in JPEG format for fluorescence spectra, described by Fisher,
et. al., cited reference (3), and shown in FIG. 2.

| | Red Sensor | Green Sensor | Blue Sensor |
|---|---|---|---|
| NC Tissue | 124 | 255 | 188 |
| IC Tissue | 169 | 180 | 108 |
| AC Tissue | 140 | 92 | 44 |

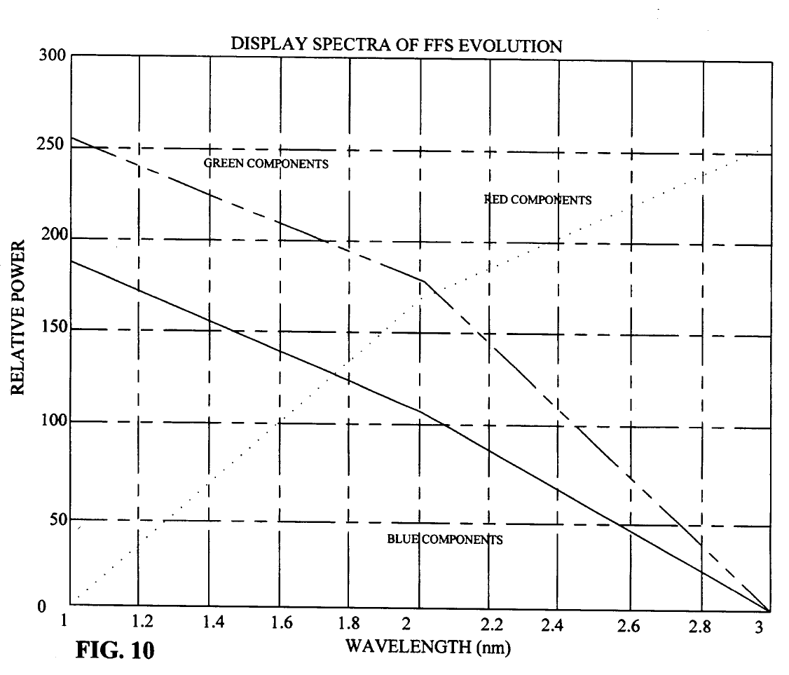

In comparing the spectra in FIGS. 7, 8 and 9, it is clear that the red spectrum doesn't change much, while the blue and green spectra change drastically. This visual observation is confirmed by the energy values shown in TABLE I and plotted in FIG. 10. In this demonstration of the method the characteristics in FIG. 10 identify and quantify the evolution from healthy to diseased tissue.

### EXAMPLE 2

### Displaying the Spectral Changes for Easy Recognition

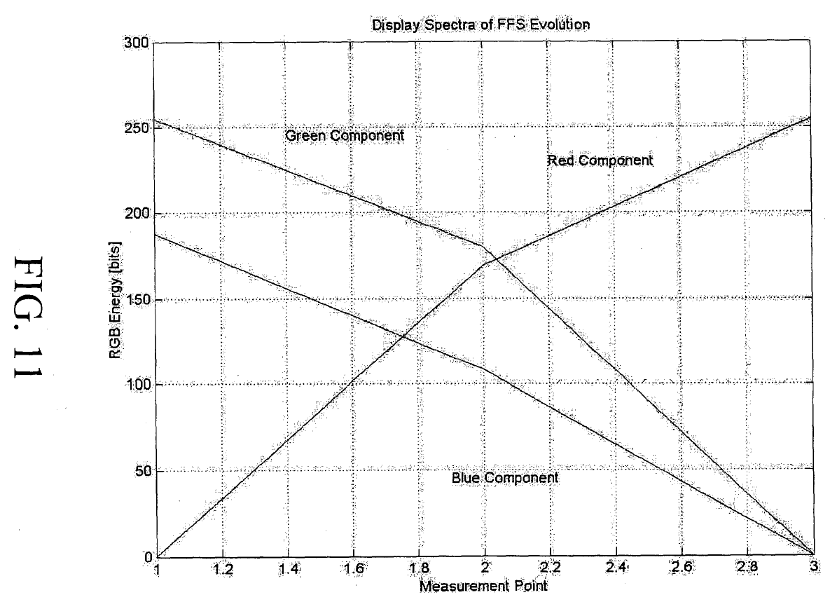

The second step in this simulation is based on past expectations that diseased tissue will look redder than healthy tissue. The color transition is enhanced by removing the red component from the NC image and the blue and green components from the AC image. In this simple demonstration the IC spectra, and the remaining components of NC and AC is kept unchanged. This word description is quantified as the desired display values shown in TABLE II and plotted in FIG. 11.

TABLE II
Desired display values for fluorescence spectra of TABLE I

| | Red Sensor | Green Sensor | Blue Sensor |
|---|---|---|---|
| NC Tissue | 0 | 255 | 188 |
| IC Tissue | 169 | 180 | 108 |
| AC Tissue | 255 | 0 | 0 |

### EXAMPLE 3

### Transforming Spectral Measurements to Displaying Spectra for Easy Recognition

The third step is to evaluate the three components at each stage of Caries Evolution recorded in FIG. 10 and transform them into the corresponding display components in FIG. 11, a direct analogy to the bright white to medium red transformation discussed above. The transformation uses the relation that the red value displayed (R_{d}) is related to the measured values of red (Rₘ), green (Gₘ), and blue (Bₘ). For example, R_{mnc} is the measured energy stored in red sensor when photographing No Caries tissue. A similar matrix (display) may be written to describe the spectra for displaying No Caries, Initial Caries and Advanced Caries tissue, as follows:

$$\begin{matrix}measure = ( \begin{matrix}{R}_{mNC} & {R}_{mIC} & {R}_{mAC} \\ {G}_{mNC} & {G}_{mIC} & {G}_{mAC} \\ {B}_{mNC} & {B}_{mIC} & {B}_{mAC}\end{matrix} ) \\ display = ( \begin{matrix}{R}_{dNC} & {R}_{dIC} & {R}_{dAC} \\ {G}_{dNC} & {G}_{dIC} & {G}_{dAC} \\ {B}_{dNC} & {B}_{dIC} & {B}_{dAC}\end{matrix} ) \\ enhance = ( \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} )\end{matrix}$$

The two energy matrices are related algebraically by the transformation matrix enhance: display=enhance*measure. This representation is the modern computer representation of simultaneous algebraic equations as learned in high school algebra, though in this case there are nine simultaneous equations, more than normally encountered in high school. Typical of the nine equations contained in this representation is R_{dNC}=a₁R_{mNC}+a₂G_{mNC}+a₃B_{mNC}, where a₁, a₂, and a₃ are three of the nine unknown values (enhancement coefficients) to be determined by solving the nine simultaneous equations. These coefficients transform the measured image into the displayed image. In words, this equation says that the amount of red displayed for sound tissue is obtained by summing the product of the measured red component with a red enhancement coefficient, the product of the measured green component with a green enhancement coefficient, and the product of the measured blue component with a blue enhancement coefficient. The solution is represented in computer symbols (which can be performed automatically by the computer) as enhance=display*(measure)⁻¹. After the transformation is computed (only once for a specific application) the values displayed are obtained using the formula:

$$( \begin{matrix}{R}_{d} \\ {G}_{d} \\ {B}_{d}\end{matrix} ) = ( \begin{matrix}{a}_{1} & {a}_{2} & {a}_{3} \\ {b}_{1} & {b}_{2} & {b}_{3} \\ {c}_{1} & {c}_{2} & {c}_{3}\end{matrix} ) * ( \begin{matrix}{R}_{m} \\ {G}_{m} \\ {B}_{m}\end{matrix} )$$

Based on the spectral values shown in Examples 1 and 2, the following calculations can be made to solve the coefficients aₙ.

$$Symbolically \text{:} {\underline{R}}_{d} ≡ ( \begin{matrix}0 \\ 169 \\ 255\end{matrix} ) = ( \begin{matrix}124 & 255 & 188 \\ 169 & 180 & 108 \\ 140 & 92 & 44\end{matrix} ) ( \begin{matrix}{a}_{1} \\ {a}_{2} \\ {a}_{3}\end{matrix} ) ≡ ( A ) \underline{a}$$

The modern computer solution is written symbolically: a=[A]⁻¹R_{d}. Similar solutions are obtained for green and blue by replacing R_{d} first by:

$${\underline{G}}_{d} = ( \begin{matrix}255 \\ 180 \\ 0\end{matrix} )$$

(the [A] matrix remains the same) and solving: b=[A]⁻¹G_{d}, then replacing R_{d} by:

$${\underline{B}}_{d} = ( \begin{matrix}188 \\ 108 \\ 0\end{matrix} )$$

and solving c=[A]⁻¹B_{d}

In this demonstration, the values in (enhance) are:

$$( \begin{matrix}{a}_{1} & {b}_{2} & {c}_{3} \\ {b}_{1} & {b}_{2} & {b}_{2} \\ {c}_{1} & {c}_{2} & {b}_{3}\end{matrix} ) ( \begin{matrix}5.83 & - 12.14 & 12.62 \\ - 6.09 & 19.06 & - 20.47 \\ - 2.88 & 8.52 & - 8.66\end{matrix} )$$

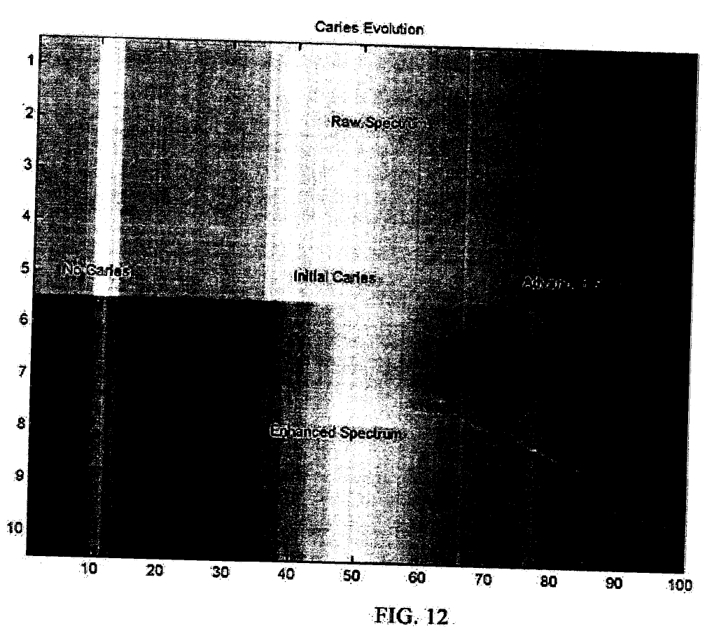

In this simulation a sequence of 100 hypothetical measurements were created by interpolating between NC and IC values for points 1 to 49, and between IC and AC values for points 50 to 100. These sets of data were then processed using the algorithm above. The upper half of FIG. 12 shows the original colors of the hypothetical measurements portraying the evolution of sound tissue to diseased tissue. The lower half of FIG. 12 shows the corresponding colors of the enhanced image. The enhanced change from sound tissue on the left to diseased tissue on the right is clearly evident.

### EXAMPLE 4

### An Alternative Transformation of Spectral Measurements

Inspection of the transition of spectral components with the evolution of lesions in FIG. 10 suggest that the ratio of spectral components rather than specific colors may indicate the evolution of a lesion.

This hypothesis was tested using the detection ratio:

d=Rₘ/(Gₘ+Bₘ),

where Rₘ, Gₘ, and Bₘ are the red, green, and blue components respectively.

The ratio of red to blue and green increases monotonically as the lesion develops and is thus a good indicator of the evolution. Since the image is expected to become more red as the lesion develops, no red with maximum green and blue is used to indicate sound tissue and maximum red with no blue or green is used to indicate carious tissue.

At any intermediate point, the color components may be scaled between these extreme values. The form of scaling, for the red component, is R_{d}=k₁₁+k₁₂d_{NC} where R_{d} is the displayed component, k₁₁ and k₁₂ are scaling coefficients determined by the computer (see below), and d_{NC} is the measured value of d for sound tissue (no Caries). Corresponding equations are written for green and blue. The resulting set of three equations with six unknown scaling coefficients may be written in vector/matrix form as:

d=[k]m (Equation 1)

where:

$$\underline{d} ≡ ( \begin{matrix}{R}_{d} \\ {G}_{d} \\ {B}_{d}\end{matrix} ) , [ k ] ≡ ( \begin{matrix}{k}_{11} & {k}_{12} \\ {k}_{21} & {k}_{22} \\ {k}_{21} & {k}_{32}\end{matrix} ) , and \underline{m} = ( \begin{matrix}1 \\ m\end{matrix} )$$

Six equations are needed to determine the six unknown scaling coefficients and make up two equations for each color component, one using the measured values at the minimum detection ratio (sound tissue) and the other using the measured values at the maximum detection ratio (diseased tissue). In vector matrix form the two equations for red are:

$${\underline{R}}_{d} ≡ ( \begin{matrix}{R}_{dNC} \\ {R}_{dAC}\end{matrix} ) = ( \begin{matrix}0 \\ 255\end{matrix} ) = ( \begin{matrix}1 & {m}_{NC} \\ 1 & {m}_{A C}\end{matrix} ) ( \begin{matrix}{k}_{11} \\ {k}_{12}\end{matrix} )$$

Corresponding equations, G_{d} and B_{d} are written for green and blue. The three vector matrix equations are combined, for easier computer solution, into one equation:

$$[ D ] = {[ M ] [ k ]}^{T} where [ D ] = [ \begin{matrix}{\underline{R}}_{d} & {\underline{G}}_{d} & {\underline{B}}_{d}\end{matrix} ] , \\ M = ( \begin{matrix}1 & {m}_{NC} \\ 1 & {m}_{A C}\end{matrix} ) , {and [ k ]}^{T} = ( \begin{matrix}{k}_{11} & {k}_{21} & {k}_{31} \\ {k}_{12} & {k}_{22} & {k}_{32}\end{matrix} )$$

The solution for the values scaling coefficients kₘₙ is written:

[k]^{T}=[M]⁻¹[D]

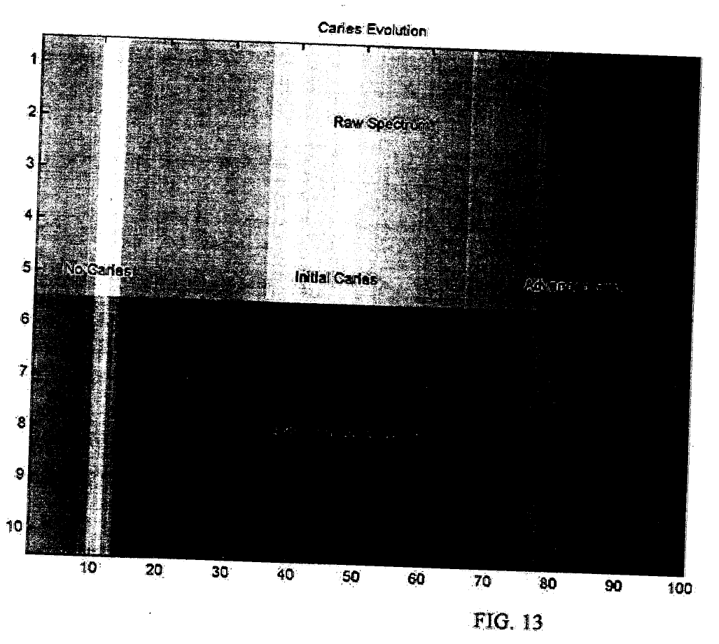

The computer calculates the inverse matrix [m]⁻¹ and multiplies it by the matrix D to obtain the numerical values of the matrix k. Equation 1 is applied to the measured values of red, green, and blue at each pixel to obtain the displayed values. The results obtained by applying this method to the data in FIG. 9, are compared to the original data as shown in FIG. 13.

It is evident from FIGS. 12 and 13 that when the method of the present invention is applied, an enhanced image showing color distinction between the sound tissue and the diseased tissue can be displayed. The sound tissue will appear green or blue-green, while the advanced diseased tissue will appear red. The intermediate diseased tissue including the initial stage of caries will appear as a mixed color, easily distinguishable from the sound tissue and the advanced diseased tissue.

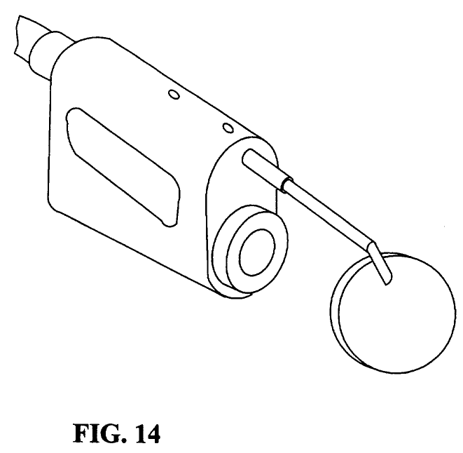

Further, the present invention provides a system for detecting development stages of a disease comprising: a recording device capable of recording an image of a target issue. The recording device may be a still or a video digital camera that is configured for capturing fluorescence spectral values of the target tissue similar to commercial device 10, shown in FIG. 14. It is contemplated that if the target tissue is disposed within a confined area, for example, a tooth in a patient's mouth, the camera may define a hand-held probe that can reach the target issue to record the spectral values. As indicated hereinabove, a suitable camera may have RGB sensors and JPEG format. Other cameras using other sensor/format systems such as CMY, CMYG, or other image formats such as TIFF may also be used.

The system of the present invention further comprises a processor operably coupled with the recording device for processing the recorded fluorescence spectral values and producing spectral data representing a plurality of regions of the target tissue; software operably coupled with the processor, the software enabling transformation of the spectral data into enhanced data representing an enhanced image of the plurality of regions of the target tissue; and a display screen operably coupled with software for displaying the enhanced image of the plurality of regions of the target tissue. The processor may be a commercially available general purpose computer or a custom digital processor designed specifically for the present purpose. The transformation is performed in accordance with an algorithm provided in the present invention.

As shown in FIG. 14, the system of the present invention may provide device 10 having light source 11 attached to camera 12. Light source 11 provides narrow bandwidth light near the ideal excitation wavelength. Light source 11 may be a Xenon light with appropriate filtering or a laser source to produce a specific colored light for illumination of the target tissue. For example, a blue filter may be used to produce blue light for inducing a carious tooth to emit fluorescence light. Light source 11 may be attached to a light guide configured to enter a restricted area such as a mouth. Device 10 may have mirror 13 attached thereon to provide uniform illumination of the area.

An example of an operation of the system of the present invention may be demonstrated as follows. A user, such as a dentist, uses device 10 to check inside the mouth of a patient. The light source 11 provides blue light to a target tooth, which, in response, emits a spectrum of fluorescent light. Camera 12 records these fluorescence spectral values from the tooth, which is then sent to the processor (not shown) for processing into digital data. The software, which is typically provided in a computer (not shown), receives the processed data and transforms the data using pre-programmed calculation steps to produce enhanced data. Finally, the enhanced image representing an enhanced image of the tooth may be displayed on the display screen (not shown). The user observing the enhanced image will be able to easily distinguish the areas representing different stages of tooth caries by the differing colors appeared in the enhanced image.

While the present invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

Cited References:

1. Hefferren, J. J. et al: Tooth enamel II, p. 161 Bristol: John Wright & Sons Ltd. 1971.

2. Angmar-Mansson, B. and ten Bosch, J. J.: Quantitative light-induced fluorescence (QLF): a method for assessment of incipient caries lesions, pp. 298-307 Dentomaxillofacial Radiology 30 (2001).

3. Fisher, M., Feller, L. and Schechter, I.: Tooth-Caries Early Diagnosis and Mapping by Fourier Transform Spectral Imaging Fluorescence, pp. 225-232 Instrumentation Science & Technology, 30(2) (2002).

What is claimed is:

1. A method for enhancing imaging of diseased tissue comprising the steps of:
(a) quantifying fluorescence spectral values of a plurality of tissue regions of a target tissue, wherein the plurality of tissue regions represents stages of development of a disease;
(b) transforming the fluorescence spectral values to produce enhanced spectral values for each tissue region; and
(c) displaying an enhanced image of the plurality of tissue regions using the transformed spectral values.

2. The method of claim 1, wherein said transforming step (b) includes multiplying the spectral values with predetermined enhancing coefficients to produce the enhanced spectral values, the enhancing coefficients calculated based on spectral changes during the stages of development of the disease.

3. The method of claim 2, wherein the step of quantifying (a) includes measuring fluorescence intensity of each tissue region at a range of wavelengths representing a red spectrum (R), a green spectrum (G) and a blue spectrum (B).

4. The method of claim 3 wherein said step of quantifying (a) further comprises the step of recording the fluorescence spectral values using a digital camera having sensors corresponding to R, G, and B, and producing a digital image having a plurality of pixels,
wherein the fluorescence spectral value recorded by the sensor corresponding to R is represented by a red component (Rₘ), the fluorescence spectral value recorded by the sensor corresponding to G is represented by a green component (Gₘ), and the fluorescence spectral value recorded by the sensor corresponding to B is represented by a blue component (Bₘ) of each pixel.

5. The method of claim 4, wherein said transforming step (b) includes modifying at least one of: Rₘ, Gₘ, and Bₘ of at least one of the plurality of tissue regions to produce the enhanced spectral values for each tissue region,
wherein an enhanced red component (R_{d}) corresponds to the modified Rₘ, the enhanced green component (G_{d}) corresponds to the modified Gₘ, and an enhanced blue component (B_{d}) corresponds to the modified Bₘ of each pixel.

6. The method of claim 5, wherein said displaying (c) includes displaying the enhanced image of the plurality of tissue regions by digital imaging using R_{d}, G_{d}, and B_{d} of each pixel for each tissue region.

7. The method of claim 2 wherein the plurality of tissue regions comprises: a region of healthy tissue, a region of initial diseased tissue, and a region of advanced diseased tissue.

8. The method of claim 7, wherein the target tissue is a tooth.

9. The method of claim 8, wherein the region of healthy tissue shows no caries (NC), the region of initial diseased tissue shows initial caries (IC), and the region of advanced diseased tissue shows advanced caries (AC).

10. The method of claim 9, wherein the fluorescence spectral values are obtained from measuring fluorescence intensity of NC, IC and AC at a range of wavelengths representing a red spectrum (R), a green spectrum (G) and a blue spectrum (B),
wherein said step of quantifying (a) further comprises the step of recording the fluorescence spectral values of NC, IC, and AC using a digital camera having sensors corresponding to R, G, and B, producing a digital image having a plurality of pixels,
wherein the fluorescence spectral value recorded by the sensor corresponding to R is represented by an R component (Rₘ), the fluorescence spectral value recorded by the sensor corresponding to G is represented by a green component (Gₘ), and the fluorescence spectral value recorded by the sensor corresponding to B is represented by a blue component (Bₘ) of each pixel for NC, IC and AC.

11. The method of claim 10 wherein said transforming step (b) includes optionally modifying Rₘ to produce an enhanced red component (R_{d}), optionally modifying Gₘ to produce an enhanced green component (G_{d}), and optionally modifying Bₘ to produce an enhanced blue component (B_{d}) of each pixel for corresponding NC, IC and AC.

12. The method of claim 11 wherein R_{d} of NC is substantially lower than R_{d} of AC, G_{d} of NC is substantially higher than G_{d} of AC, and B_{d} of NC is optionally substantially higher than B_{d} of NC.

13. The method of claim 12, wherein R_{d} of NC is equal to zero (0), and G_{d} of AC and B_{d} of AC are equal to zero (0).

14. The method of claim 11, wherein
R_{d} of each NC, IC, and AC represents a first linear relationship of Rₘ, Gₘ, and Bₘ of corresponding NC, IC, and AC, respectively,
G_{d} of each NC, IC, and AC represents a second linear relationship of Rₘ, Gₘ, and Bₘ of corresponding NC, IC, and AC, respectively, and
B_{d} of each NC, IC, and AC represents a third linear relationship of Rₘ, Gₘ, and Bₘ of corresponding NC, IC, and AC, respectively.

15. The method of claim 14, wherein the first linear relationship is represented by:
R_{d}=a₁Rₘ+a₂Gₘ+a₃Bₘ,
wherein the second linear relationship is represented by:
G_{d}=b₁Rₘ+b₂Gₘ+b₃Bₘ,
wherein the third linear relationship is represented by:
B_{d}=c₁Rₘ+c₂Gₘ+c₃Bₘ,
wherein R_{d} represents R_{d} of NC, IC, or AC; G_{d} represents G_{d} of NC, IC, or AC; B_{d} represents B_{d} of NC, IC, or AC; Rₘ represents Rₘ of corresponding NC, IC, or AC; Gₘ represents Gₘ of corresponding NC, IC, or AC; Bₘ represents Bₘ of corresponding NC, IC, or AC; a₁, a₂, a₃, b₁, b₂, b₃, c₁, c₂, and c₃ represent predetermined coefficients at each pixel.

16. The method of claim 15 wherein said step of displaying (c) includes producing digital imaging of the enhanced image of NC, IC, and AC by using corresponding R_{d}, G_{d}, and B_{d}.

17. The method of claim 14, wherein R_{d} is represented by:
R_{d}=k₁₁+k₁₂d,
G_{d}=k₂₁+k₂₂d,
B_{d}=k₃₁+k₃₂d,
wherein R_{d} represents R_{d} of NC, IC, or AC; G_{d} represents G_{d} of NC, IC, or AC; B_{d} represents B_{d} of NC, IC, or AC; d represents the ratio: Rₘ/(Gₘ+Bₘ), wherein Rₘ represents Rₘ of corresponding NC, IC, or AC; Gₘ represents Gₘ of corresponding NC, IC, or AC, and Bₘ of corresponding NC, IC, or AC; k₁₁, k₁₂, k₂₁, k₂₂, k₃₁, k₃₂ represent previously determined coefficients.

18. The method of claim 17 wherein said step of displaying (c) includes producing digital imaging of the enhanced image of NC, IC, and AC by using corresponding R_{d}, G_{d}, and B_{d}.

19. A system for detecting development stages of a disease comprising:
a recording device capable of recording an image of a target tissue having a plurality of regions representing stages of development of a disease, said recording device recording fluorescence spectral values from the plurality of regions;
a processor operably coupled with said recording device for processing the recorded fluorescence spectral values and producing spectral data representing to the plurality of regions of the target tissue;
software operably coupled with said processor for enabling a transformation of spectral data into enhanced spectral data representing an enhanced image of the plurality of regions of the target tissue, the transformation including multiplying the spectral data with predetermined enhancing coefficients, the predetermined enhancing coefficients calculated based on spectral changes during stages of disease development; and
a display screen operably coupled with software for displaying the enhanced image of the plurality of regions of the target tissue, wherein the plurality of regions are distinguishable by color.

20. The system of claim 19 further comprising a camera probe electronically connected with the recording device, configured to enter restricted area to record the image of the target tissue.

21. The system of claim 19 further comprising a light source for inducing the target tissue to produce fluorescence spectral values.

22. The system of claim 19, wherein said recording device is a digital camera.

23. The system of claim 19, wherein said recording device is a video camera.

24. The system of claim 22 wherein said recording device has a spectral sensors for recording fluorescence spectral values corresponding to the wavelengths representing a plurality of spectra.

25. The system of claim 24, wherein said sensors comprise:
a sensor for recording fluorescence values representing a red spectrum;
a sensor for recording fluorescence values representing a green spectrum; and
a sensor for recording fluorescence values representing a blue spectrum.

26. The system of claim 19 wherein said software is provided in a computer defining said display screen.

27. The system of claim 26 wherein said display screen is configured to display a plurality of colors corresponding to the enhanced spectral data.

28. The system of claim 27 wherein said display screen is configured to digitally display the enhanced image.

29. The system of claim 19 adapted to detect a tooth disease.

30. The system of claim 29 adapted to detect tooth caries.
